(19) United States
(12) Patent Application Publication
(10) Pub. No.: US 2011/0200914 A1
(43) Pub. Date: Aug. 18, 2011

(54) HIGH POWER DIRECT OXIDATION FUEL CELL

(76) Inventors: Chao-Yang Wang, State College, PA (US); Yongjun Leng, State College, PA (US); Xiaoming Huang, State College, PA (US); Takashi Akiyama, Osaka (JP)

(21) Appl. No.: 12/706,649

(22) Filed: Feb. 16, 2010

(51) Int. Cl. H01M 4/02

(52) U.S. Cl. 429/523

(57) ABSTRACT

A high power density direct oxidation fuel cell (DOFC) with comprising an anode electrode with a microporous layer (MPL) configured to alleviate cathode dryout and thus reduce electrode resistance in the cathode that interfaces with a hydrocarbon membrane. The MPL is configured to alleviate cathode dryout by comprising a fluoropolymer and an electrically conductive material, wherein the MPL is loaded with fluoropolymer in the range from about 10 to about 25 wt. %.

### FIELD OF THE INVENTION

The present disclosure relates generally to fuel cells, fuel cell systems, and electrodes/electrode assemblies for the same. More specifically, the present disclosure relates to electrodes with improved diffusion media, suitable for direct oxidation fuel cells (hereinafter “DOFC”), such as direct methanol fuel cells (hereinafter “DMFC”), and their fabrication methods.

### BACKGROUND OF THE DISCLOSURE

A DOFC is an electrochemical device that generates electricity from electrochemical oxidation of a liquid fuel. DOFC's do not require a preliminary fuel processing stage; hence, they offer considerable weight and space advantages over indirect fuel cells, i.e., cells requiring preliminary fuel processing. Liquid fuels of interest for use in DOFC's include methanol, formic acid, dimethyl ether, etc., and their aqueous solutions. The oxidant may be substantially pure oxygen or a dilute stream of oxygen, such as that in air. Significant advantages of employing a DOFC in portable and mobile applications (e.g., notebook computers, mobile phones, personal data assistants, etc.) include easy storage/handling and high energy density of the liquid fuel.

One example of a DOFC system is a DMFC. A DMFC generally employs a membrane-electrode assembly (hereinafter “MEA”) having an anode, a cathode, and a proton-conducting polymer electrolyte membrane (hereinafter “PEM”) positioned therebetween. A typical example of a PEM is one composed of a perfluorosulfonic acid—tetrafluorethylene copolymer having a hydrophobic fluorocarbon backbone and perfluorosether side chains containing a strongly hydrophilic pendant sulfonic acid group (SO₃H), such as NAFION® (Nafion® is a registered trademark of E.I. Dupont de Nemours and Company). When exposed to water, the hydrolyzed form of the sulfonic acid group (SO₃⁻H₃O⁺) allows for effective proton (H⁺) transport across the membrane, while providing thermal, chemical, and oxidative stability. In a DMFC, a methanol/water solution is directly supplied to the anode as the fuel and air is supplied to the cathode as the oxidant. At the anode, the methanol reacts with the water in the presence of a catalyst, typically a Pt or Ru metal-based catalyst, to produce carbon dioxide, H⁺ ions (protons), and electrons. The electrochemical reaction is shown as equation (1) below:

CH₃OH+H₂O→CO₂+6H⁺+6e⁻ (1)

During operation of the DMFC, the protons migrate to the cathode through the proton-conducting membrane electrolyte, which is non-conductive to electrons. The electrons travel to the cathode through an external circuit for delivery of electrical power to a load device. At the cathode, the protons, electrons, and oxygen molecules, typically derived from air, are combined to form water. The electrochemical reaction is given in equation (2) below:

3/2O₂+6H⁺+6e⁻→3H₂O (2)

Electrochemical reactions (1) and (2) form an overall cell reaction as shown in equation (3) below:

CH₃OH+3/2O₂→CO₂+2H₂O (3)

Notwithstanding the above-described advantageous characteristics of perfluorosulfonic acid-tetrafluoroethylene copolymers (e.g., NAFION®) when utilized as a PEM in DOFCs, a drawback of perfluorinated membranes is their propensity for methanol to partly permeate the membrane, such permeated methanol being termed “crossover methanol.” The crossover methanol reacts with oxygen at the cathode, causing a reduction in fuel utilization efficiency and cathode potential, with a corresponding reduction in power generation of the fuel cell. It is thus conventional for DMFC systems to use excessively dilute (3-6% by vol.) methanol solutions for the anode reaction in order to limit methanol crossover and its detrimental consequences. However, a problem with such a DMFC system is that it requires a significant amount of water to be carried in a portable system, thus diminishing the system energy density.

In view of the foregoing, it is considered desirable for the PEMs of DMFCs to have high proton conductivity and a low methanol crossover rate. Disadvantageously however, currently available, state of the art perfluorinated PEMs have relatively high methanol crossover rates which adversely affect fuel cell performance due to cathode mixed potentials and low fuel efficiency. As a consequence, much effort has focused on developing alternative PEMs having lower methanol crossover rates along with minimum reduction in proton conductivity. In this regard, hydrocarbon-base PEMs have evidenced promise in attaining these attributes, and several hydrocarbon-based PEMs have demonstrated low methanol crossover rates and other favorable attributes, such as excellent chemical and mechanical stability. However, due to poor water transport properties of hydrocarbon membranes, a DOFC based on hydrocarbon membranes limits the achievement of high power densities. The cathode contains proton conducting ionomer (usually perfluorinated polymer) which is hydrated in order to exhibit high proton conductivity. Otherwise, the cathode performance declines. If the water transport property of the membrane is poor, there is insufficient water coming from the anode, thus leading to the cathode dryout (insufficient water inside the cathode catalyst layer to hydrate the proton conducting ionomer). Proton conduction in the catalyst layer is kept with the ionomer in the catalyst layer and needs water to perform proton conduction. However, if the water discharge from cathode catalyst layer exceeds the water input (water generation plus water transport from the anode size), the ionomer loses water and proton conductivity decreases, which results in a decline in cathode performance.

The ability to use highly concentrated fuel is desirable for portable power sources, particularly since DMFC technology is currently competing with advanced batteries, such as those based on lithium-ion technology. In view of the foregoing, there exists a need for improved DOFC/DMFC systems and methodologies, including electrodes and gas diffusion media, which facilitate operation of such systems for obtaining optimal performance with very highly concentrated fuel and high power efficiency. Thus, applying hydrocarbon membranes in DMFC so as to reduce methanol crossover is necessary. At the same time, high power density of a DMFC using hydrocarbon membrane is desirable from cost and volume considerations. In this subject matter, methods are disclosed to achieve high power density of a DMFC using hydrocarbon membranes by alleviating the problem of cathode dryout and high electrode resistance.

### SUMMARY OF THE DISCLOSURE

An advantage of the present disclosure is an improved high power density DMFC.

The improved high power density DMFC can be achieved by alleviating cathode dryout and thus reducing electrode resistance in the cathode that interfaces with a hydrocarbon membrane.

According to an aspect of the present disclosure, the foregoing and other advantages are achieved in part by employing a lower PTFE loading in the anode microporous layer (MPL). Preferably PTFE loading in the anode MPL is in the range of 5 to 25 wt %.

Another aspect of the present disclosure for achieving reduced cathode dryout is by using polymer materials whose wetting property is between PTFE and Nafion as a binder for the anode MPL, such as polysulfone, carboxylated polystyrene or nylon.

According to another aspect of the present disclosure, reduced cathode dyrout is achieved by employing low equivalent-weight (EW) ionomer in the fabrication of the cathode electrode. Under dry conditions, low-EW ionomer will maintain relatively high proton conductivity and hence minimize the electrode resistance in the cathode.

Yet another aspect of the present disclosure for alleviating cathode dryout is achieved by adding hygroscopic materials in the cathode electrode such that the cathode can retain more water and hence lower the electrode resistance. Preferred embodiments include heteropolyacids such as ZrP and ZrSPP or oxides such as ZrO₂, TiO₂ and SiO₂.

Another aspect of the present disclosure is to employ more hydrophilic cathode gas diffusion layer (GDL) and/or cathode MPL in order for the cathode electrode to retain more water and hence to lower the electrode resistance.

Additional advantages of the present disclosure will become readily apparent to those skilled in this art from the following detailed description, wherein only the preferred embodiments of the present disclosure are shown and described, simply by way of illustration but not limitation. As will be realized, the disclosure is capable of other and different embodiments, and its several details are capable of modification in various obvious respects, all without departing from the spirit of the present invention. Accordingly, the drawings and description are to be regarded as illustrative in nature, and not as restrictive.

### BRIEF DESCRIPTION OF THE DRAWING

The various features and advantages of the present disclosure will become more apparent and facilitated by reference to the accompanying drawings, provided for purposes of illustration only and not to limit the scope of the invention, wherein the same reference numerals are employed throughout for designating like features and the various features are not necessarily drawn to scale but rather are drawn as to best illustrate the pertinent features, wherein:

FIG. 1 is a simplified, schematic illustration of a DOFC system capable of operating with highly concentrated methanol fuel, i.e., a DMFC system.

FIG. 2 is a schematic, cross-sectional view of a representative configuration of a membrane electrode assembly suitable for use in a fuel cell/fuel cell system such as the DOFC/DMFC system of FIG. 1.

FIG. 3 is a graph comparing DMFC performance using standard PTFE loading (40 wt %) in the anode MPL with the less amount (10 wt %).

FIG. 4 is a graph illustrating a 2-hours discharge curve of the advanced MEA disclosed herein and its comparison to conventional MEA.

FIG. 5 is a graph illustrating a power density as a function of PTFE content.

### DETAILED DESCRIPTION OF THE DISCLOSURE

The present disclosure relates to fuel cells and fuel cell systems with high power conversion efficiency, such as DOFC's and DOFC systems operating with highly concentrated fuel, e.g., DMFC's and DMFC systems fueled with about 5 to about 25 M methanol (CH₃OH), and electrodes/electrode assemblies therefor.

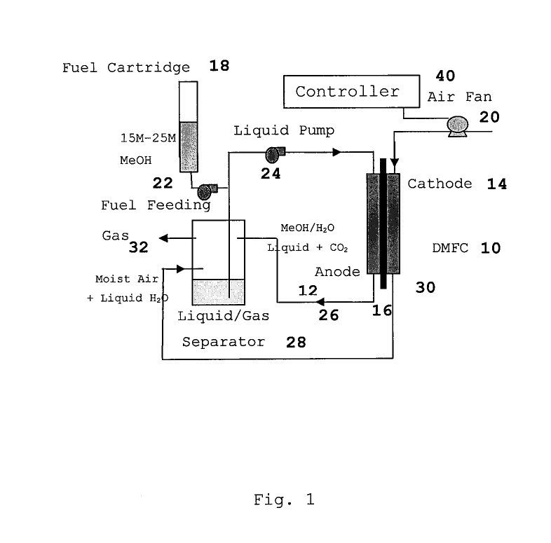

Referring to FIG. 1, schematically shown therein is an illustrative embodiment of a DOFC system adapted for operating with highly concentrated fuel, e.g., a DMFC system 10, which system maintains a balance of water in the fuel cell and returns a sufficient amount of water from the cathode to the anode under high-power and elevated temperature operating conditions. (A DOFC/DMFC system is disclosed in co-pending, commonly assigned U.S. patent application Ser. No. 11/020,306, filed Dec. 27, 2004).

As shown in FIG. 1, DMFC system 10 includes an anode 12, a cathode 14, and a proton-conducting electrolyte membrane 16, forming a multi-layered composite membrane-electrode assembly or structure 9 commonly referred to as an MEA. Typically, a fuel cell system such as DMFC system 10 will have a plurality of such MEA's in the form of a stack; however, FIG. 1 shows only a single MEA 9 for illustrative simplicity. Frequently, the MEA's 9 are separated by bipolar plates that have serpentine channels for supplying and returning fuel and by-products to and from the assemblies (not shown for illustrative convenience). In a fuel cell stack, MEAs and bipolar plates are aligned in alternating layers to form a stack of cells and the ends of the stack are sandwiched with current collector plates and electrical insulation plates, and the entire unit is secured with fastening structures. Also not shown in FIG. 1, for illustrative simplicity, is a load circuit electrically connected to the anode 12 and cathode 14.

A source of fuel, e.g., a fuel container or cartridge 18 containing a highly concentrated fuel 19 (e.g., methanol), is in fluid communication with anode 12 (as explained below). An oxidant, e.g., air supplied by fan 20 and associated conduit 21, is in fluid communication with cathode 14. The highly concentrated fuel from fuel cartridge 18 is fed directly into liquid/gas (hereinafter “L/G”) separator 28 by pump 22 via associated conduit segments 23′ and 25, or directly to anode 12 via pumps 22 and 24 and associated conduit segments 23, 23′, 23″, and 23″′.

In operation, highly concentrated fuel 19 is introduced to the anode side of the MEA 9, or in the case of a cell stack, to an inlet manifold of an anode separator of the stack. Water produced at the cathode 14 side of MEA 9 or cathode cell stack via electrochemical reaction (as expressed by equation (2)) is withdrawn therefrom via cathode outlet or exit port/conduit 30 and supplied to liquid/gas separator 28. Similarly, excess fuel, water, and carbon dioxide gas are withdrawn from the anode side of the MEA 9 or anode cell stack via anode outlet or exit port/conduit 26 and supplied to L/G separator 28. The air or oxygen is introduced to the cathode side of the MEA 9 and regulated to maximize the amount of electrochemically produced water in liquid form while minimizing the amount of electrochemically produced water vapor, thereby minimizing the escape of water vapor from system 10.

The DOFC/DMFC system 10 shown in FIG. 1 comprises at least one MEA 9 which includes a polymer electrolyte membrane 16 and a pair of electrodes (an anode 12 and a cathode 14) each composed of a catalyst layer and a gas diffusion layer sandwiching the membrane. Typical polymer electrolyte materials include fluorinated polymers having perfluorosulfonate groups or hydrocarbon polymers such as poly-(arylene ether ether ketone) (hereinafter “PEEK”). The electrolyte membrane can be of any thickness as, for example, between about 25 and about 180 μm. The catalyst layer typically comprises platinum or ruthenium based metals, or alloys thereof. The anodes and cathodes are typically sandwiched by bipolar separator plates having channels to supply fuel to the anode and an oxidant to the cathode. A fuel cell stack can contain a plurality of such MEA's 9 with at least one electrically conductive separator placed between adjacent MEA's to electrically connect the MEA's in series with each other, and to provide mechanical support.

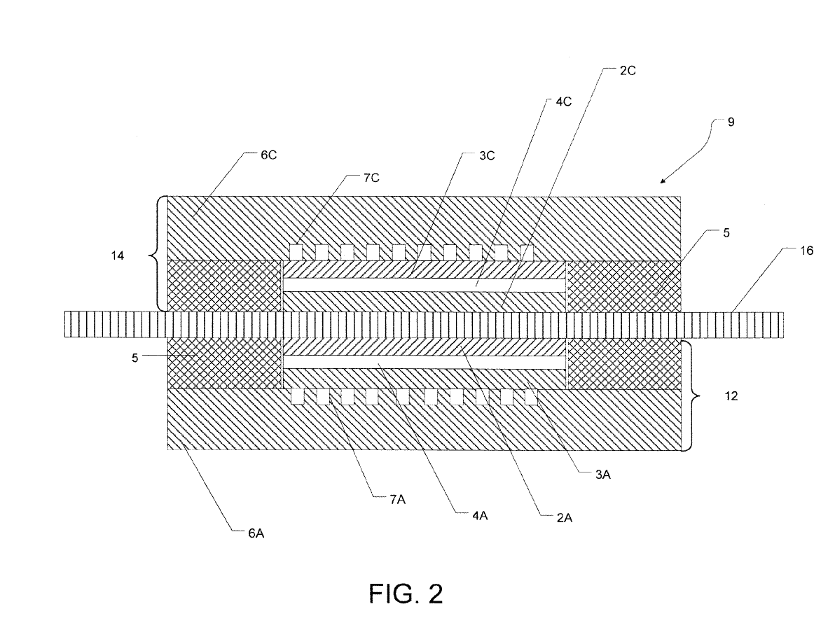

Referring now to FIG. 2, shown therein is a schematic, cross-sectional view of a representative configuration of a MEA 9 for illustrating its various constituent elements in more detail. As illustrated, a cathode electrode 14 and an anode electrode 12 sandwich a polymer electrolyte membrane 16 made of a material, such as described above, adapted for transporting hydrogen ions from the anode to the cathode during operation. The anode electrode 12 comprises, in order from electrolyte membrane 16, (1) a metal-based catalyst layer 2_{A} in contact therewith; (2) an intermediate, hydrophobic micro-porous layer (MPL) 4_{A}; and (3) and an overlying gas diffusion layer (GDL) 3_{A}. The cathode electrode 14 comprises, in order from electrolyte membrane 16: (1) a metal-based catalyst layer 2_{C} in contact therewith; (2) an intermediate, hydrophobic micro-porous layer (MPL) 4_{C}; and (3) an overlying gas diffusion medium (GDM) 3_{C}. GDL 3_{A} and GDM 3_{C} are each gas permeable and electrically conductive, and may be comprised of a porous carbon-based material including a carbon powder and a fluorinated resin, with a support made of a material such as, for example, carbon paper or woven or non-woven cloth, felt, etc. Metal-based catalyst layers 2_{A} and 2_{C} may, for example, comprise Pt or Ru.

The anode MPL 4_{A} shown in FIG. 2, is loaded with 5 to 25 wt % PTFE to promote water crossover from the anode to the cathode, thus alleviating cathode dyrout and increasing the power density of the DMFC.

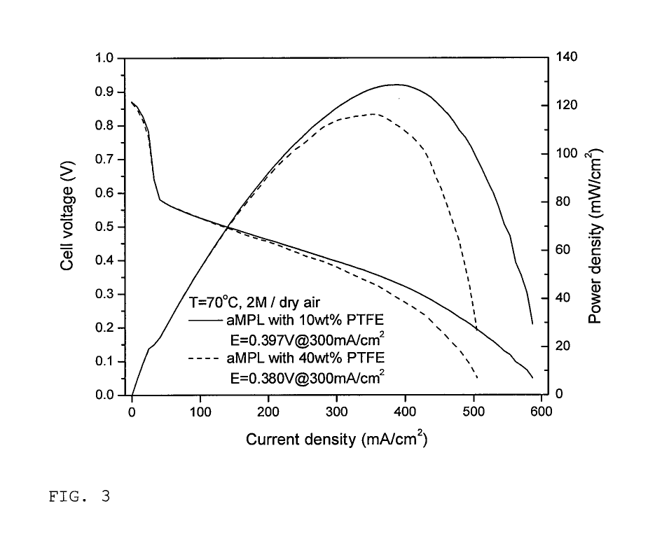

As graphically illustrated in FIG. 3, a comparison of current-voltage performance curves of DMFCs using a hydrocarbon membrane, with the anode MPL of 10 wt % and conventional 40 wt % PTFE shows that, the cell power density at the elevated temperature of 70° C. and under dry conditions is improved with the use of 10 wt % PTFE in the anode MPL, versus the conventional 4 wt % PTFE.

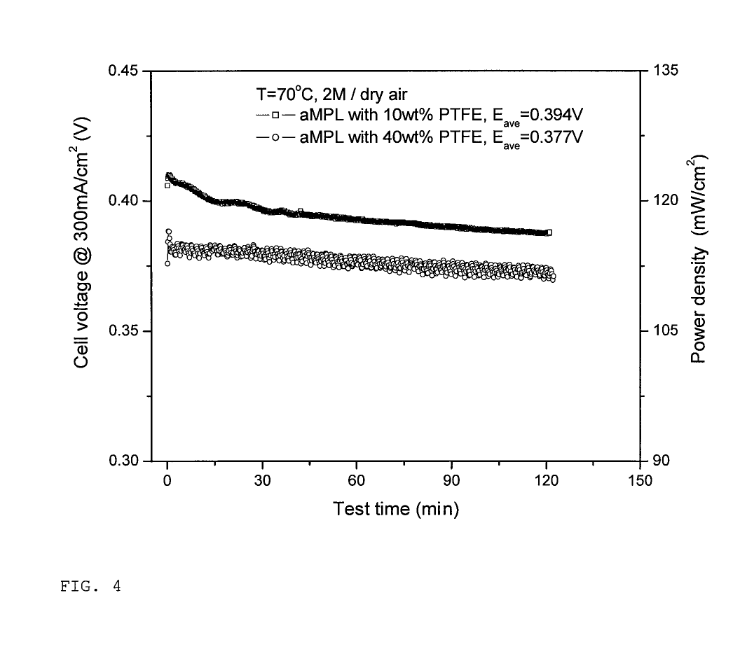

FIG. 4 shows the superior performance of the present MEA using 10 wt % PTFE loaded anode MPL in a 2-hour discharge process. Other PTFE loadings in the range of 5 to 25 wt % were also tested and showed similar benefits for MEAs using hydrocarbon membranes.

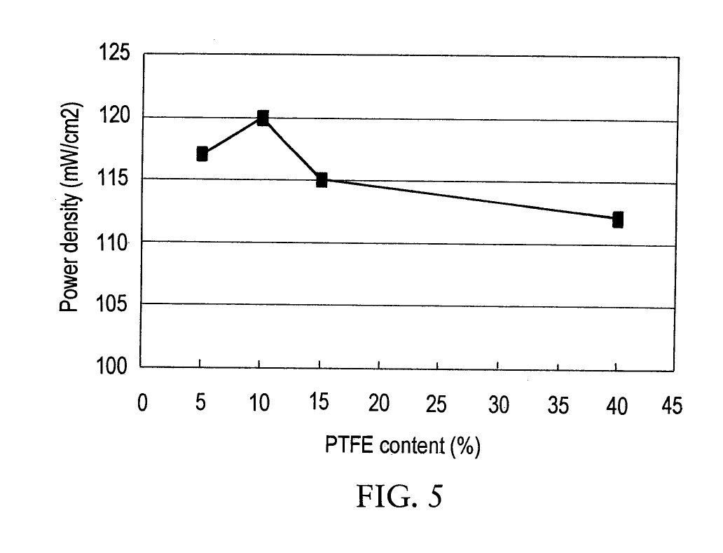

FIG. 5 shows power density as a function of PTFE content. Power density is optimized when the PTFE content is between 5-10 wt %.

Reduced cathode dryout is achieved by employing low equivalent-weight (EW) ionomer in the fabrication of the cathode electrode. Under dry conditions, low-EW ionomer will maintain relatively high proton conductivity and hence minimize the electrode resistance in the cathode.

Yet another aspect of the present disclosure for alleviating cathode dryout is achieved by adding hygroscopic materials in the cathode electrode such that the cathode can retain more water and hence lower the electrode resistance. Preferred embodiments include heteropolyacids such as ZrP and ZrSPP or oxides such as ZrO₂, TiO₂ and SiO₂.

Another aspect of the present disclosure is to employ more hydrophilic cathode gas diffusion layer (GDL) and/or cathode MPL in order for the cathode electrode to retain more water and hence to lower the electrode resistance.

In summary, the present disclosure describes improved anode MPL for use in DOFC/DMFC systems which facilitate operation at high power densities to promote water crossover from the anode to the cathode, thus alleviating cathode dryout and increasing the power density of the DMFC.

In addition, the disclosed methodology/technology can be practiced utilizing readily available materials. In the previous description, numerous specific details are set forth, such as specific materials, structures, reactants, processes, etc., in order to provide a better understanding of the present disclosure. However, the present disclosure can be practiced without resorting to the details specifically set forth. In other instances, well-known processing materials and techniques have not been described in detail in order not to unnecessarily obscure the present disclosure.

Only the preferred embodiments of the present disclosure and but a few examples of its versatility are shown and described in the present disclosure. It is to be understood that the present disclosure is capable of use in various other combinations and environments and is susceptible of changes and/or modifications within the scope of the disclosed concept as expressed herein.

What is claimed is:

1. An anode electrode for use in a direct oxidation fuel cell (DOFC), said anode comprising a gas diffusion medium (GDM) including a backing layer and a microporous layer, said microporous layer comprising a fluoropolymer and an electrically conductive material, wherein:
loading of said fluoropolymer in said microporous layer is in the range from about 5 wt. % to about 25 wt. %.

2. The anode as in claim 1, wherein:
said fluoropolymer comprises poly(tetrafluoroethylene) (PTFE).

3. The anode as in claim 2, wherein:
said electrically conductive material comprises carbon particles or nanofibers.

4. The anode as in claim 3, wherein:
loading of said carbon particles or nanofibers in said microporous layer is in the range from about 0.5 to about 5 mg/cm².

5. The anode of claim 1, comprising a binder for the MPL.

6. The anode of claim 5, wherein said binder is selected from the group consisting of polysulfone, carboxylated polystyrene or nylon.

7. A direct oxidation fuel cell (DOFC) comprising an anode and a cathode electrode,
wherein said anode comprises a gas diffusion medium (GDM) including a backing layer and a microporous layer, said microporous layer comprising a fluoropolymer and an electrically conductive material, and
wherein said cathode comprises a low equivalent-weight (EW) iomoner.

8. The DOFC of claim 7, wherein, said cathode comprises a hygroscopic material.

9. The DOFC of claim 8, wherein said hydgroscopic material are selected from the group consisting of ZrP, ZrSPP, ZrO₂, TiO₂ and SiO₂.

10. The DOFC of claim 7, wherein:
said fluoropolymer comprises poly(tetrafluoroethylene) (PTFE).

11. The DOFC of claim 10, wherein:
said electrically conductive material comprises carbon particles or nanofibers.

12. The DOFC of claim 11 wherein:
loading of said carbon particles or nanofibers in said microporous layer is in the range from about 0.5 to about 5 mg/cm².

13. The DOFC of claim 7, comprising a binder for the MPL.

14. The DOFC of claim 13, wherein said binder is selected from the group consisting of polysulfone, carboxylated polystyrene or nylon.

15. A direct oxidation fuel cell (DOFC) comprising an anode and a cathode electrode,
wherein said anode comprises a gas diffusion medium (GDM) including a backing layer and a microporous layer, said microporous layer comprising a fluoropolymer and an electrically conductive material, and
wherein said cathode comprises a hydrophilic gas diffusion layer (GDL) and a cathode microporous layer (MPL).
